(19) United States
(12) Patent Application Publication
(10) Pub. No.: US 2009/0107992 A1
(43) Pub. Date: Apr. 30, 2009

(54) HIGH-FREQUENCY HEATING APPARATUS

(75) Inventor: Takayuki Akashi, Nara (JP)

Correspondence Address: PEARNE & GORDON LLP, 1801 EAST 9TH STREET, SUITE 1200, CLEVELAND, OH, 44114-3108, US

(73) Assignee: PANASONIC CORPORATION, Osaka (JP)

(21) Appl. No.: 12/297,542

(22) PCT Filed: Mar. 14, 2007
(86) PCT No.: PCT/JP2007/055120

§ 371 Date: Oct. 17, 2008

(30) Foreign Application Priority Data
Apr. 17, 2006 (JP) 2006-113162

(51) Int. Cl. H05B 6/68

(52) U.S. Cl. 219/702

(57) ABSTRACT

To prevent parts within a heating chamber from melting to thereby secure the safety of a goods even when a user sets an arbitrary time and operates.

There are provided with a temperature detector 5 for detecting the temperature of a food within the heating chamber 1 in a non-contact manner, a high-frequency generator 14 for generating a microwave to heat the food within the heating chamber, and a controller 7 for controlling the high-frequency generator based on an output from the temperature detector. The controller is configured in a manner that when a user sets an arbitrary time and inputs a cooking start operation, in a menu for executing the high-frequency heating during the set time, the output level of the high-frequency generator is controlled so as to be reduced when the temperature obtained from the temperature detector increases a predetermined value or more. Since the output level for the high-frequency heating is reduced when the temperature obtained from the temperature detector increases the predetermined value or more, resin parts and ceramic parts within the heating chamber can be protected from melting.

### TECHNICAL FIELD

The present invention relates to a high-frequency heating apparatus which detects a temperature within a heating chamber in a non-contact manner and is arranged in view of safety.

### BACKGROUND ART

A high-frequency generating device using a magnetron as a high-frequency generator has a following problem. That is, if the magnetron is driven in the case where there is no food within a heating chamber, since most of a microwave provided within the heating chamber from the magnetron is reflected and returns to the magnetron, the magnetron is heated abnormally or the microwave is abnormally concentrated on parts within the heating chamber (resin parts of a door portion, a ceramic part for placing food thereon, for example) to thereby melt the parts.

In order to solve the aforesaid problem, there is proposed a high-frequency heating apparatus which automatically determine whether or not a food is actually placed within a heating chamber by utilizing an infrared sensor for detecting the temperature of a food, then when it is determined that there is no food, the heating operation by a magnetron is stopped in an early stage to thereby prevent the wasteful consumption of power and prevent the bad influence on a device due to so-called empty heating (see a patent document 1, for example). Patent Document 1: JP-A-2001-65871

### DISCLOSURE OF THE INVENTION

### Problems that the Invention is to Solve

The aforesaid high-frequency heating apparatus of the prior art is arranged in a manner that, in a microwave oven having a function of detecting the temperature of a food in a non-contact manner by using the infrared sensor arid stopping the heating when the completion of the cooking of the food is determined, after starting the heating of the food by driving the magnetron in response to the operation input of starting the cooking, the heating is also stopped when the presence/non-presence of a food can not be recognized due to the temperature distribution detected by the infrared sensor upon a lapse of a predetermined time.

The high-frequency heating apparatus of the prior art having such a function of discriminating the presence/non-presence of a food can operate effectively in a so-called automatic menu cooking for determining the completion of cooking. However, in an operation mode in which a user sets an arbitrary time to perform the high-frequency heating during the set time, the completion of cooking is determined when the set time is terminated, the user opens a door or the user performs such an operation of pushing a cancel key.

Thus, when a user sets a cooking time and starts the cooking erroneously without placing a food within the heating chamber, the apparatus operates during the set time since there is no means for safely stopping the apparatus. Accordingly, in such a case where the setting time is long, there arises a problem that a part(s) is melted and an objection is made to the apparatus in some case.

The present invention intends to solve the aforesaid problem of the prior art and an object of the present invention is to provide a high-frequency heating apparatus which detects the temperature within a heating chamber to operate safely even when a user sets a cooking time and starts the cooking erroneously without placing a food within the heating chamber.

### Means for Solving the Problems

In order to solve the problem of the prior art, the high-frequency heating apparatus according to the present invention is configured to include: a heating chamber which houses a food therein; a temperature detector which is disposed on an outer side of a wall surface of the heating chamber and detects a temperature of the food within the heating chamber in a non-contact manner; a high-frequency generator which generates a microwave to heat the food within the heating chamber; and a controller which controls the high-frequency generator based on an output from the temperature detector, wherein when a user sets an arbitrary time and inputs a cooking start operation, in a menu for executing the high-frequency heating during the set time, the controller controls the high-frequency generator so as to reduce an output level thereof when a temperature obtained from the temperature detector increases a predetermined value or more.

### Effects of the Invention

According to the present invention, even in the case where a user sets a cooking time and starts the cooking erroneously without placing a food within the heating chamber, when it is determined that the temperature within the heating chamber becomes high by detecting the temperature within the heating chamber, the heating power is reduced so as not to proceed the heating any more. Thus, the resin parts and the ceramic part within the heating chamber can be protected from melting.

### BRIEF DESCRIPTION OF THE DRAWINGS

FIG. 1 is a schematic system diagram showing the high-frequency heating apparatus according to the first embodiment of the present invention.

FIG. 2 is a front view showing a state where the door of the high-frequency heating apparatus according to the first embodiment is opened.

FIG. 3 is a diagram showing the configuration of the mechanical chamber of the high-frequency heating apparatus according to the first embodiment.

FIG. 4 is a block diagram showing the electrical configuration of the controller of the high-frequency heating apparatus according to the first embodiment.

FIG. 5 is a flowchart showing the control of the controller of the high-frequency heating apparatus according to the first embodiment.

FIG. 6 is a flowchart showing the control of the controller of the high-frequency heating apparatus according to the second embodiment.

### EXPLANATION OF SYMBOLS

1 heating chamber
2 table
5 temperature detector
6 motor
7 controller
14 high-frequency generator (magnetron)

### BEST MODE FOR CARRYING OUT THE INVENTION

The first invention is configured to include: a heating chamber which houses a food therein; a temperature detector which is disposed on an outer side of a wall surface of the heating chamber and detects a temperature of the food within the heating chamber in a non-contact manner; a high-frequency generator which generates a microwave to heat the food within the heating chamber; and a controller which controls the high-frequency generator based on an output from the temperature detector, wherein when a user sets an arbitrary time and inputs a cooking start operation, in a menu for executing the high-frequency heating during the set time, the controller controls the high-frequency generator so as to reduce an output level thereof when a temperature obtained from the temperature detector increases a predetermined value or more. Since the output level of the high-frequency heating is reduced when the temperature obtained from the temperature detector increases the predetermined value or more, the resin parts and the ceramic part within the heating chamber can be protected from melting. In addition, in the case where a user erroneously sets a heating time to be longer as required or a person such as an elderly or a child who can not determine a necessary time for heating a food sets the heating time to be longer as required, when a temperature higher than a case where a food is heated normally is detected due to any reason irrespective that the temperature of the food does not increase sufficiently, the heating operation is not stopped immediately but the output level is reduced and the heating operation can be continued. Thus, the heating cooking can be continued while suppressing the further temperature increase of the portion where the temperature higher than the case where a food is heated normally is detected, and further the usability can not be degraded.

The second invention is arranged in a manner that a plurality of the predetermined values used for the determination are provided in the high-frequency heating apparatus according to the first invention. Since the output level is further reduced when the temperature within the heating chamber increases even after the output level is reduced at the certain predetermined value, the resin parts and the ceramic part within the heating chamber can be protected from melting.

The third invention is arranged in a manner that in the high-frequency heating apparatus according to the first or second invention, the temperature detector is moved reciprocally within a preset angle so as to be able to detect temperature in a predetermined area within the heating chamber. Since the reciprocal movement enables to obtain the temperature information of a large area within the heating chamber, the abnormal situation can be detected earlier when it occurs. Thus, the parts can be protected from melting.

The fourth invention is arranged in a manner that the temperature is detected at an interval of a constant time. Since a user sets a cooking time, it is basically not necessary to determine the stopping of the cooking based on the temperature detection, that is, it is not necessary to continuously detect the temperature. Thus, the number of times for driving the temperature detector can be reduced, whereby the durability of the driving parts can be secured and the degree of pollution of a lens at the time of driving can be also reduced.

Hereinafter, embodiments according to the present invention will be explained with reference to drawings. The present invention is not limited to these embodiments.

### First Embodiment

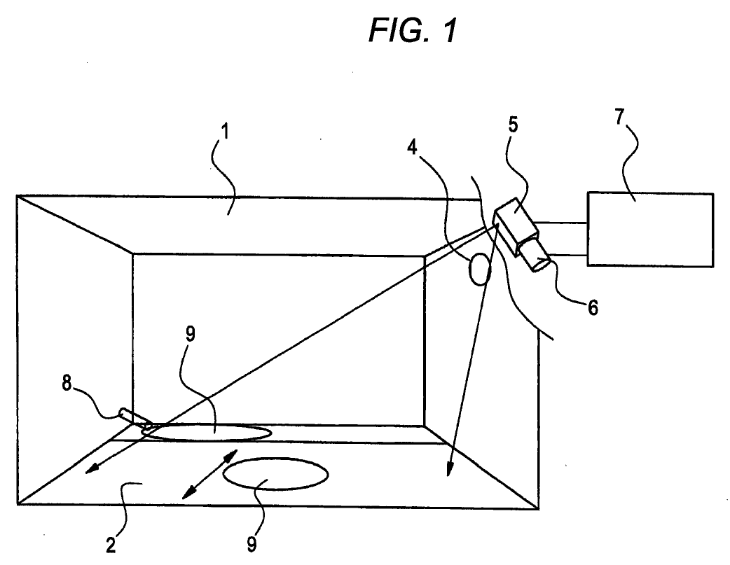

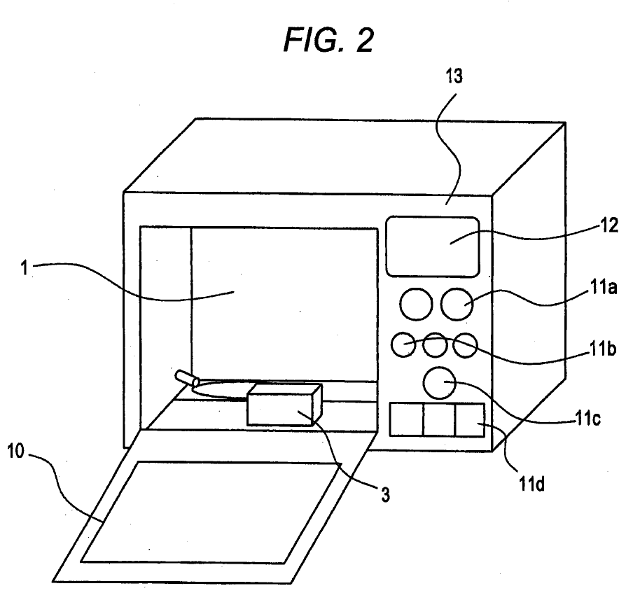

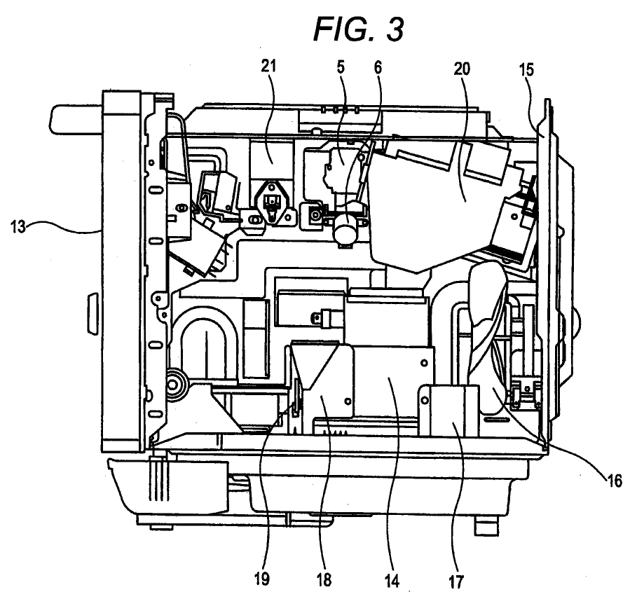

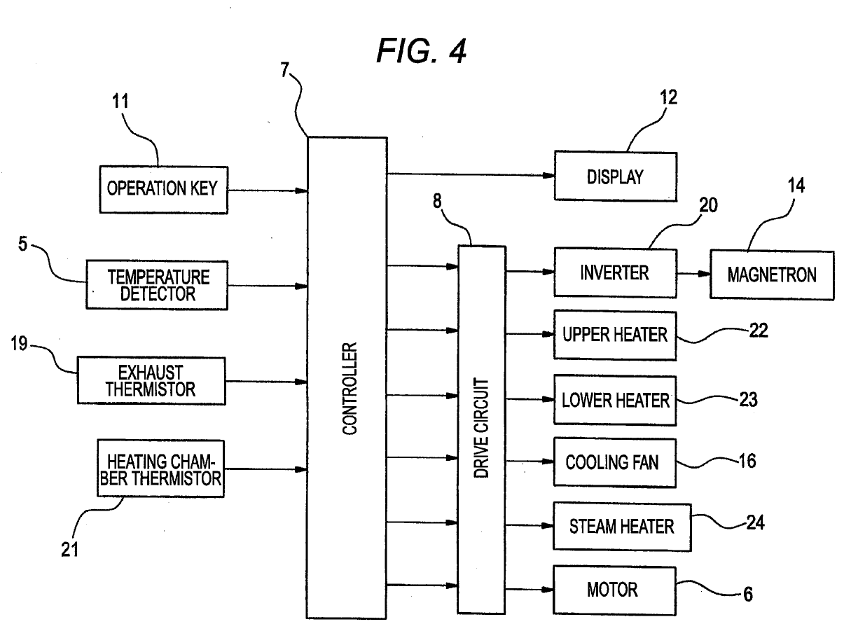

FIG. 1 is a schematic system diagram showing the high-frequency heating apparatus according to the present invention, FIG. 2 is a front view showing a state where the door of the high-frequency heating apparatus is opened, FIG. 3 is a diagram showing the configuration of a mechanical chamber seen from the front side thereof, and FIG. 4 is a block diagram showing the electrical configuration thereof.

A table 2 formed by crystallized glass cut so as to have a size fit within a heating chamber is placed on the bottom surface of the heating chamber 1. A food 3 is placed on the table 2. A temperature detection hole 4 is provided at the upper portion of the right side surface of the heating chamber so that a temperature detector 5 (for example, a temperature sensor) disposed at the outside of the wall surface of the heating chamber can detect the surface temperature of the food 3 within the heating chamber 1 in a non-contact manner. The temperature detector 5 reciprocally moves in a direction shown by an arrow by a motor 6 so as to detect the temperature in a predetermined range of the bottom surface portion within the heating chamber 1. A controller 7 controls the motor 6, and also A/D converts a voltage obtained from the temperature detector 5 to temperature data of the food 3 to thereby compare the temperature data with a predetermined value of a finished temperature of the food 3 to determine a heating time of the food 3. A water reserve portion 9 for boiling water fed from a nozzle 8 and generating steam is disposed at the inner portion of the heating chamber 1.

At the front surface of the heating chamber 1, a door 10 is openably and closably provided and an operation panel 13 is provided. The operation panel includes various kinds of operation keys 11a to 11d so that a user selects a cooking menu and starts cooking and a display portion 12 for performing necessary display. A control board (not shown) is disposed on the rear side of the operation panel 13. The controller 7 formed by a microcomputer and the drive circuit 8 for operating a heating means etc. is provided on the control board. The mechanical chamber is provided at the rear side of the operation panel.

The magnetron 14 of the high-frequency heating apparatus is disposed at the right side wall of the heating chamber 1 within the mechanical chamber. A cooling fan 16 and an air guide A17 attached to a back plate 15 are disposed on the right side of the magnetron 14 so as to cool the magnetron 14. An air guide C18 is disposed on the left side of the magnetron 14 so as to feed air within the heating chamber 1. The air guide C18 is provided with an exhaust thermistor 19 for detecting the temperature of the magnetron 14. The microwave generated by the magnetron 14 is fed to the heating chamber 1 via a waveguide (not shown) and a feeding port (not shown) provided at the bottom surface of the main body. An inverter 20 for controlling the output level of the magnetron 14 is disposed at the upper portion of the magnetron 14. The temperature detector 5 is disposed between the inverter 20 and a lamp 21 for illuminating within the heating chamber 1 etc.

FIG. 4 shows the electrical configuration. In FIG. 4, the controller 7 is arranged to receive signals from the various kinds of operation keys 11 including a start switch, the temperature detector 5, the exhaust thermistor 19 for detecting the temperature of the magnetron 14 of the high-frequency heating apparatus, and a heating chamber thermistor 21 for detecting the temperature within the heating chamber 1. The controller 7 displays a cooking time and information of accessories on the display 12 in accordance with a program stored in advance based on these signals, and also controls the magnetron 14, an upper heater 22, a lower heater 23, the cooling fan 16, a steam heater 24 and the motor 6 via the drive circuit 8. Using the inverter 20, the output level of the magnetron 14 can be controlled. Thus, for example, it enables the user to use the steam heater 24 and the high-frequency output of 300 W simultaneously.

The operation of the high-frequency heating apparatus thus configured will be explained.

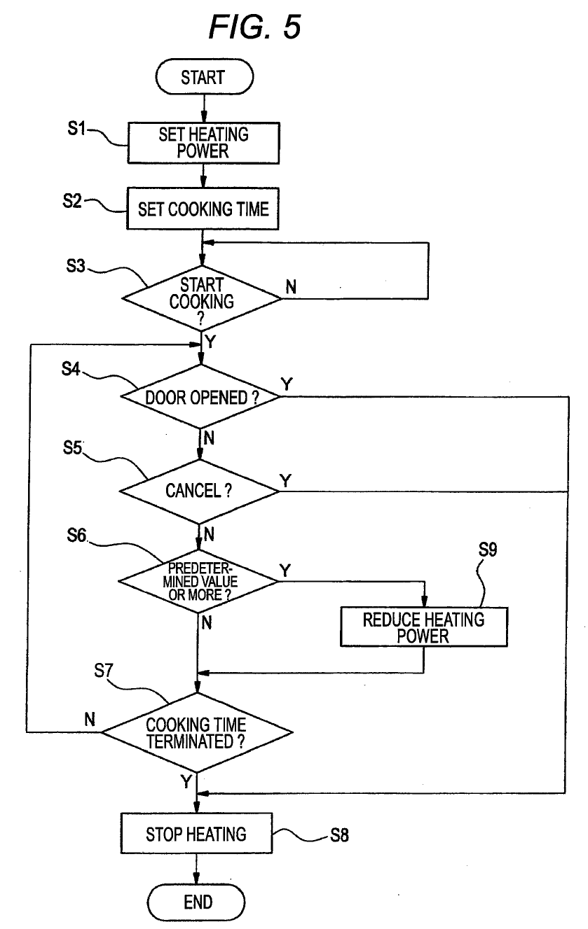

A flowchart of FIG. 5 shows portions relating to the gist of the present invention among the control performed by the controller 7 and such portions will be explained together with the related functions thereof.

When a user heats a food, the user taps the “oven output switching” key of the operation keys 11b to thereby select the output power of the high-frequency heating (step S1). The high-frequency heating apparatus of the embodiment is set in a manner that 600W output is selected when the key is tapped at first, and then the output power is switched 300W, 150W and 100W sequentially in response to the succeeding tapping operations. In this case, it is supposed that the 600W output is selected. Next, the user sets an operation time by rotating the dial of the operation key 11C (step S2). The maximum cooking time is set so as to be selectable up to 30 minutes when the user selects 600W or 300W as the output power of the high-frequency heating apparatus, and selectable up to 5 hours when the user selects 150W or 100W. Next, the user pushes “a start key” to start the heating cooking (step S3).

As methods for determining whether or not the heating is to be stopped during the heating cooking, at first, the controller 7 monitors whether or not the door 10 is opened (step S4). When the door 10 is closed, the controller monitors whether or not the “cancel” key of the operation keys 11d is pushed (step S5). The heating operation can be stopped at an arbitrary time by opening the door 10 or pushing the “cancel” key even if a cooking time does not reach the cooking operation time set by the user (step S8).

In the high-frequency heating apparatus of the prior art, when the door 10 is closed and the “cancel” key is not operated, the controller 7 monitors only whether or not the cooking time reaches the cooking time set by the user (step S7). According to the present invention, the temperature detector 5 monitors the temperature within the heating chamber 1 in a step between step S5 and step S7 (step S6). In general, when heating a food, since water of the food is heated, the temperature of the food increases up to about 100 degrees centigrade at the maximum. On the other hand, when the heating operation is performed without placing any food within the heating chamber, the table 2 for placing a food thereon is heated abnormally by the high-frequency heating and so the crystallized glass forming the table may be melted. When the glass melts, the temperature reaches 300 degrees centigrade or more. According to the present invention, although the temperature within the heating chamber is monitored in step S6, when it is detected that the monitored temperature increases 120 degrees centigrade or more, that is set as a predetermined value 1, the process proceeds to step S9, whereat the output power of the high-frequency heating apparatus is reduced to 450W. When a user selects the output of 300W or less at the first, the determination procedure of step S6 is not executed. Further, the determination procedure of step S6 is to be executed at every 30 seconds. In the case of the automatic menu cooking in which the temperature of a food is detected and the cooking is stopped in response to the detection result, the temperature of a food is monitored frequently. However, in this case, since a user sets the cooking time, the temperature detection is merely required to determine whether or not the temperature is in an abnormal state. Thus, the frequency of the temperature detection is reduced to one fifth as compared with that at the time of the automatic menu cooking so as to take the durability of the driving device into consideration. When the temperature detector is driven when a food is heated, the lens surface of the temperature detector may be polluted by scattered pieces of the food which is heated and burst. Thus, the present invention takes such the influence on the pollution into consideration by reducing the frequency of driving of the temperature detector.

In this manner, even in the case where a user sets a cooking time and starts the cooking erroneously without placing a food within the heating chamber, the high-frequency output power is reduced when a temperature higher than that in the case where a food is heated normally is detected. Thus, the table 2 for placing a food thereon is prevented from melting and so the apparatus can be used safely.

### Second Embodiment

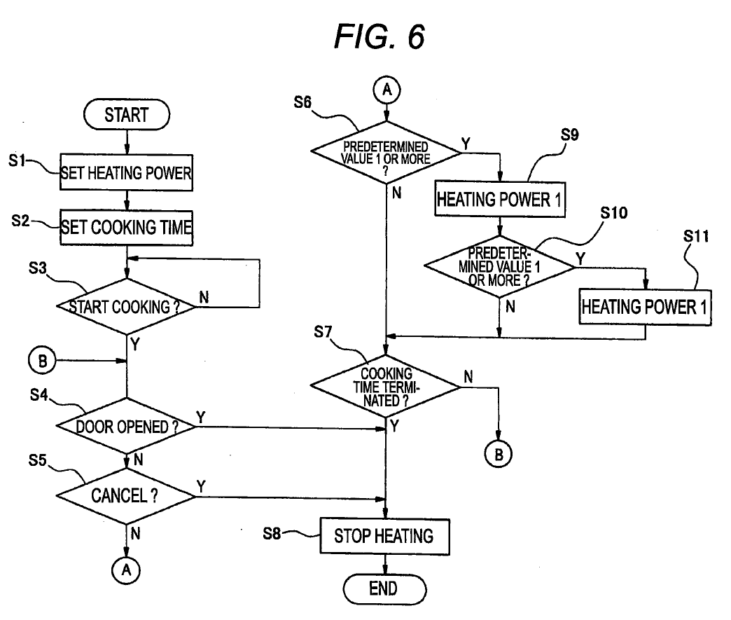

Next, the second embodiment according to the present invention will be explained with reference to FIG. 6. In the figure, portions identical or similar to those of the first embodiment are omitted or simplified in their explanation.

This embodiment is arranged to provide a plurality of branches in the process in the case where the temperature within the heating chamber 1 is high, as compared with the first embodiment. When it is detected in step S6 that the temperature within the heating chamber 1 increases 120 degrees centigrade, the power is reduced to 450W in step S9. Normally, that the temperature within the heating chamber 1 reduces once since the heating power reduces. However, when the heating of 450W is continued, the temperature within the heating chamber 1 increases again. Thus, in step S10, the temperature within the heating chamber 1 is compared with a predetermined value 2. In the present invention, the predetermined value 2 is set also to 120 degrees centigrade which is the same as the predetermined value 1. When the temperature within the heating chamber 1 increases the predetermined value 2, that is, 120 degrees centigrade, even if the power is reduced to 450W, the process proceeds to step S11, whereat the power-off is set as a heating power 2. Although the remaining cooking time is displayed on the display 12, the output power is placed in a state where no microwave is generated. Thus, the temperature within the heating chamber 1 does not increase.

In this manner, if a user sets a cooking time and starts the cooking erroneously without placing a food within the heating chamber, the high-frequency output power is reduced when a temperature higher than that in the case where a normal food is heated is detected. Even in this case, however, if the temperature within the heating chamber increases, the high-frequency output is stopped. Thus, the table 2 for placing a food thereon is prevented from melting and so the apparatus can be used safely.

The present application is based on Japanese Patent Application (Japanese Patent Application No. 2006-113162) filed on Apr. 17, 2006, the content of which is incorporated herein by reference.

### INDUSTRIAL APPLICABILITY

As described above, according to the high-frequency heating apparatus of the present invention, even in the case where a user sets a cooking time and starts the cooking erroneously without placing a food within the heating chamber, the high-frequency output power is reduced when a temperature higher than that in the case where a normal food is heated is detected. Thus, the resin parts and the ceramic part within the heating chamber can be prevented from melting in advance and so the apparatus can be used safely. The apparatus can be used as a high-frequency heating apparatus for home use and business use.

1. A high-frequency heating apparatus comprising:
a heating chamber which houses a food therein;
a temperature detector which is disposed on an outer side of a wall surface of the heating chamber and detects a temperature of the food within the heating chamber in a non-contact manner;
a high-frequency generator which generates a microwave to heat the food within the heating chamber; and
a controller which controls the high-frequency generator based on an output from the temperature detector, wherein
when a user sets an arbitrary time and inputs a cooking start operation, in a menu for executing the high-frequency heating during the set time; the controller controls the high-frequency generator so as to reduce an output level thereof when a temperature obtained from the temperature detector increases a predetermined value or more.

2. A high-frequency heating apparatus according to claim 1, wherein
the controller includes a plurality of the predetermined values and reduces the output level of the high-frequency heating stepwise.

3. A high-frequency heating apparatus according to claim 1, wherein
the temperature detector is moved reciprocally within a preset angle so as to be able to detect temperature in a predetermined area within the heating chamber.

4. A high-frequency heating apparatus according to claim 3, wherein
the control means detects the temperature at an interval of a constant time.
